(19) United States
(12) Patent Application Publication
(10) Pub. No.: US 2006/0021641 A1
(43) Pub. Date: Feb. 2, 2006

(54) Crockery basket for a diswasher and handle for a crockery basket

(75) Inventors: Hubert Groll, Modingen (DE); Rainer Schutz, Neresheim (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 10/527,884

(22) PCT Filed: Nov. 19, 2003
(86) PCT No.: PCT/EP03/12962

§ 371 Date: Mar. 15, 2005

(30) Foreign Application Priority Data
Dec. 17, 2002 (DE) 102 59 087.7

(51) Int. Cl. B08B 3/02

(52) U.S. Cl. 134/135; 134/201; 134/200

(57) ABSTRACT

A crockery basket for a dishwashing machine includes a front side and a handle (1) secured to the front side for movement about a horizontal axis and configured to move outwardly in the opening direction of a door (5) of the dishwashing machine in response to opening of the door (5).

The invention relates to a crockery basket for a dishwashing machine and a handle for a crockery basket.

Crockery baskets, in particular upper baskets for dishwashing machines, consist of a basket unit, a wire mesh, which is mostly fitted encased in plastic and with relatively large mesh size, whereby both the permeability of the rinse water and the size of the individual crockery items (glasses, cups, etc.) are taken into consideration. To either pack or empty a crockery basket the latter is taken out of a washing container in the dishwashing machine. For this purpose the crockery baskets are mounted on rails, which permit the crockery baskets to fully slide out from the washing container of the dishwashing machine via an equalising mechanism. After a door of the dishwashing machine is opened the user normally grasps a wire mesh piece, which can be grasped by chance, preparatory to pulling the crockery basket fully out of the washing container of the dishwashing machine. It is desirable to stack the crockery basket according to the respective divisions with saucers, glasses, cups etc., though reality dictates that all possible free space is utilised for placing also smaller objects such as for example schnapps glasses, egg cups, mocha cups, etc. in the crockery basket. With a crockery basket stacked in this way it can be quite difficult to make out a suitable spot on the crockery basket for pulling the latter from the washing container. In fact, the basket can be pulled out of the washing container by a non-central region on the front side of the cutlery basket, which can be gripped, though there is the risk here that the castors or wheels will jam somewhat due to one-sided tensile loading on the crockery basket and thus cause the crockery basket to buck, whereby the objects not properly stacked in the crockery basket, glasses for example, can be set in motion and knock against one another, with the result that crockery or glasses may get broken.

The object of the present invention is therefore to provide a crockery basket, which also permits a crockery basket not properly loaded to be pulled reliably and securely from the washing container without however losing valuable packing space.

This task is solved by the inventive crockery basket according to claim 1 and by the inventive handle for a crockery basket according to the other independent claim. Advantageous further developments of the invention are characterised in the dependent claims.

In an inventive crockery basket for a dishwashing machine, essentially consisting of a basket unit, is according to the present invention on the front side of the crockery basket at least one handle is pivotably mounted around a horizontal axis, said handle being arranged and embodied in such a manner that when the door of the dishwasher is opened, the handle pivots in the direction of the opening door. The thus pivoted handle can be gripped by the hand of the user and ensures the introduction of a controlled traction force to the crockery basket.

According to a preferred embodiment of the invention the swinging procedure of the handle in the direction of the opening door is based only on the influence of gravity on the handle. Alternatively, it is also possible to support this swinging procedure of the handle in the direction of the opening door with a pre-tensed spring element, for example by a spring element resting on the crockery basket.

By way of advantage the handle is arranged on the front side of the crockery basket such that the handle is pivoted in after the crockery basket is fully pushed into the washing container only by the door being closed.

The inventive handle for a crockery basket of a dishwashing machine has a first section, designed to be gripped by the human finger, a second section, designed to be connected to braided elements of the crockery basket positively and a third section, which can be supported opposite the crockery basket.

According to an advantageous embodiment of the invention the second section is configured with a snap-lock element for positive connection with a cylindrical wire section of the crockery basket. This snap-lock element can appropriately comprise a thermoplastic ring element, which is fitted with a notch, in order to be arranged over a horizontal cylindrical wire section of the crockery basket in the manner of a snap-lock connection. In this way the second section of the inventive handle is designed such that it can also be attached to existing crockery baskets by means of the snap-lock connection.

The present invention provides a crockery basket, which also allows a crockery basket not properly stacked to be withdrawn reliably and securely from the washing container without losing valuable packing space.

The present invention will now be explained hereinbelow in greater detail by means of diagrams, in which:

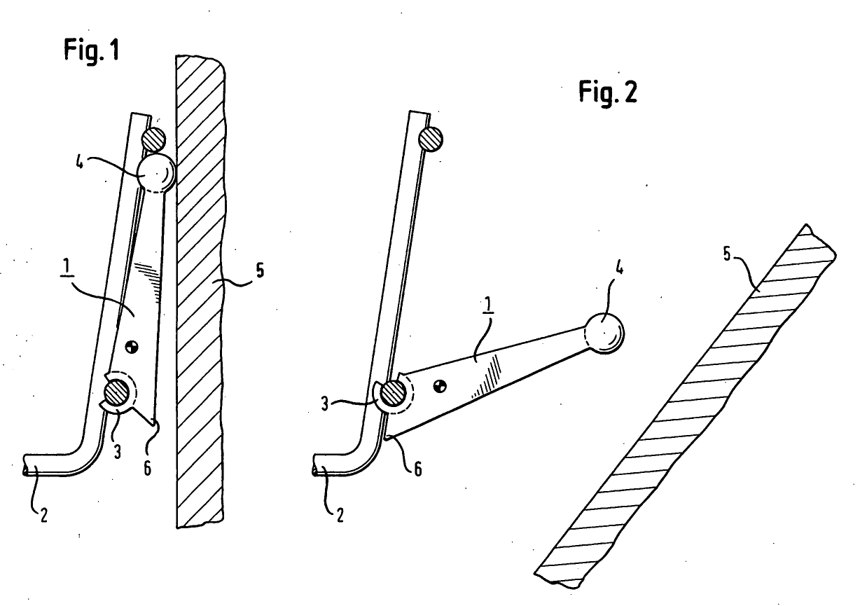

FIG. 1 shows a section of an inventive crockery basket with an inventive handle in the swung-in state with the door of a dishwashing machine closed, and

FIG. 2 shows a section of an inventive crockery basket with an inventive handle in a swung-out state, whereby the door of the dishwashing machine is opened.

In the arrangement according to FIG. 1 a section of an inventive crockery basket 2 of a dishwashing machine, not illustrated here in greater detail, is shown, whereby a handle 1 in a second section is connected via the bearing 3 positively to a horizontally running wire section of the crockery basket 2 and is thus pivotably mounted about a horizontal axis. Due to the closed dishwashing machine door 5 the handle 1 is swung in. In this state the handle 1 has no function.

After the dishwashing machine door 5 is opened and the same is swung out (see FIG. 2) gravity works on the handle 1 such that the latter pivots out of its rest position and offers the user of the dishwashing machine the handle cap 4 (illustrated in section). This swinging procedure is terminated by the support of a shoulder 6, so that comfortable gripping of the handle cap 4 is possible.

To attain pivoting out of the handle 1 caused only by gravity, the centre of gravity of the inventive handle 1 must be, when in the not pivoted out state, outside the plumb line running through the centre of gravity in the bearing 3.

Alternatively it is also possible to support this swinging procedure of the handle 1 in the direction of the opening door 5 with a pre-tensed spring element, for example through a suitable spring element, which is supported on the crockery basket 2.

In order to constantly ensure the pivoting out and pivoting in procedure of the handle 1 on the crockery basket 2, the handle 1 should thus be of such a size that the influence of gravity is so great that the pivoting out is guaranteed. A third section of the handle 1 is designed as a shoulder 6, supported after a predetermined angle of pivot has been reached on the crockery basket 2 and thus hinders any further pivoting out of the handle 1. The angle of pivot is appropriately such that a human hand can comfortably grasp the handle cap 4, which forms a first section of the handle. For this purpose the handle 1 or respectively the handle cap 4 is configured ergonomically such that the hand of an adult can grasp it without undue problem, and also so that it is possible for elderly people to pull out a loaded upper basket without difficulty.

The length of the handle 1 and/or of the handle cap 4 should be such that the basket can be reliably pulled along transport rails in the dishwashing machine, however a two-handed grip is also possible to make it easier for older people for example to pull out the crockery basket 2.

Apart from positioning centrally in the frontal area of the crockery basket 2 it is also possible to arrange handles flush on the right and/or left sides to likewise facilitate the crockery basket 2 to be drawn out with two hands.

The handle 1 is dimensioned effectively such that after the crockery basket 2 is pushed in the door 5 of the dishwashing machine can be closed without problem and on contact with the handle 1 pivots the latter into a rest position.

The second section of the inventive handle 1, the bearing 3, is designed with a snap-lock element for positive connection to a cylindrical wire section of the crockery basket 2, thus also enabling a crockery basket without a handle to be retrofitted. This snap-lock connection element can appropriately consist of a thermoplastic ring element, which is fitted with a notch in order to be arranged over a horizontal cylindrical wire section of the crockery basket 1 in the way of a snap-lock connection.

The present invention provides a crockery basket 2 allowing also a crockery basket 2 which is not properly stacked to be withdrawn reliably and securely from the washing container without losing valuable storage space.

1-6. (canceled)

7. A crockery basket for a dishwashing machine comprising:
a front side; and
at least one handle (1) secured to the front side for movement about a horizontal axis and configured to move outwardly in the opening direction of a door (5) of the dishwashing machine in response to opening of the door (5).

8. The crockery basket as claimed in claim 7, wherein the handle (1) is configured to move outwardly in the opening direction of a door (5) of the dishwashing machine in response to opening of the door (5) based only on the influence of gravity on the handle (1).

9. The crockery basket as claimed in claim 7 and further comprising a pre-tensed spring element for urging the handle (1) to move outwardly in the opening direction of a door (5) of the dishwashing machine in response to opening of the door (5).

10. The crockery basket as claimed in claim 7, wherein the handle (1) is arranged on the front side of the crockery basket (2) such that pivoting in of the handle (1) takes place only by the door being closed after the crockery basket (2) is fully pushed into the washing container.

11. A handle for a crockery basket of a dishwashing machine claimed in claim 7, wherein the handle (1) has a first section (4) operable to be gripped, a second section (3), designed to be connected around braided elements of the crockery basket (2), and a third section (6), that is supported relative to the crockery basket (2).

12. The handle as claimed in claim 11, wherein the second section (3) includes a snap-lock element for a positive connection with a cylindrical wire section of the crockery basket (2).
